(19) United States
(12) Patent Application Publication
(10) Pub. No.: US 2016/0169086 A1
(43) Pub. Date: Jun. 16, 2016

(54) COMBUSTION CHAMBER WITH DUCTS FOR INTERNAL COMBUSTION ENGINES

(71) Applicant: Caterpillar Inc., Peoria, IL (US)

(72) Inventor: Kenth I. Svensson, Peoria, IL (US)

(73) Assignee: Caterpillar Inc., Peoria, IL (US)

(21) Appl. No.: 15/051,693

(22) Filed: Feb. 24, 2016

(51) Int. Cl. F02B 23/02

(52) U.S. Cl. CPC F02B 23/02

(57) ABSTRACT

An internal combustion engine is provided. The internal combustion engine includes an engine cylinder, a piston, a cylinder head, a combustion chamber, and a fuel injector. The cylinder head has a depression of predefined shape such that an effective width of the depression of cylinder head is greater than a diameter of the engine cylinder. The combustion chamber is defined as an enclosure between the depression of the cylinder head and a crown of the piston. The fuel injector is adapted to supply fuel to the combustion chamber via a number of orifices. In an alternate embodiment, the combustion chamber is provided with a number of ducts adapted to provide a passage to the fuel exiting from the orifices. The ducts extend at a predefined angle with an axis of the engine cylinder to facilitate injection of the fuel towards the depression of the cylinder head within the combustion chamber.

### TECHNICAL FIELD

The present disclosure relates to a combustion chamber of an internal combustion engine, and more specifically, to the combustion chamber having a predefined shape that allows for a longer free-jet combustion duration in the internal combustion engine.

### BACKGROUND

In general, an internal combustion engine includes a combustion chamber where a mixture of fuel and intake charge (i.e. air that may include diluents such as re-circulated exhaust gases) is ignited to produce power. The combustion chamber is generally formed by a recess in a cylinder head on one side and by a recess in a top of a piston on another side. The design of the combustion chamber has a significant impact on the thermal efficiency and emissions of the internal combustion engine.

In the current design of combustion chambers, the combusting flame may impinge directly on the top of the piston, inducing thermal stresses in the piston. The piston is typically cooled to reduce the impact of these thermal stresses. Also, spray targeting of fuel jets with injection timing makes combustion of the fuel and air mixture affect emissions. Therefore, there is a need in the art for a combustion chamber that reduces thermal stresses in the piston and provides combustion of the fuel and air mixture that is less dependent on injection timing.

U.S. Pat. No. 4,898,136A (hereinafter reference '136) discloses a mixture-compressing spark-ignition internal-combustion engine. The mixture-compressing spark-ignition internal-combustion engine having a main combustion chamber and an auxiliary combustion chamber in a cylinder head. The cylinder head has a depression serving as a main combustion chamber. The auxiliary combustion chamber is provided with a spark plug and is connected to the main combustion chamber by an overflow bore through which a part of the fuel/air mixture from the main combustion chamber is compressed by a piston. After ignition has taken place, the fuel/air mixture leaves at high pressure and velocity as an ignition jet with a jet direction aiming at a surface region of the piston crown. The overflow bore is aligned concentrically with respect to the longitudinal center axis of the cylinder. The surface region of the piston crown is designed as a level impact area lying opposite the overflow bore and running orthogonally with respect to the jet direction of the ignition jet. However, as described in the patent publication '136, the combusting flame impinges directly on the piston crown inducing thermal stresses in the piston crown. Therefore there is a need of a combustion chamber that reduces thermal stresses in the piston and facilitates combustion that is less dependent on injection timing in the internal combustion engine.

### SUMMARY OF THE DISCLOSURE

In one aspect of the present disclosure, an internal combustion engine is provided. The internal combustion engine includes an engine cylinder, a piston, a cylinder head, a combustion chamber, and a fuel injector. The piston is disposed within the engine cylinder and adapted to perform reciprocating movement within the engine cylinder. The cylinder head is adapted to cover the engine cylinder. The cylinder head has a depression of a predefined shape such that an effective width of the depression of the cylinder head is greater than a diameter of the engine cylinder. The combustion chamber is defined as an enclosure between the depression in the cylinder head and a crown of the piston. The fuel injector is in fluid communication with the combustion chamber. The fuel injector is adapted to supply fuel to the combustion chamber via a number of orifices.

Other features and aspects of this disclosure will be apparent from the following description and the accompanying drawings.

### BRIEF DESCRIPTION OF THE DRAWINGS

FIG. 1 illustrates a side sectional view of an in-line multi-cylinder internal combustion engine, each cylinder having a combustion chamber, in accordance with an embodiment of the present disclosure;

FIG. 2 illustrates a side sectional view of the in-line multi-cylinder internal combustion engine, each cylinder having a combustion chamber with ducts, in accordance with an alternate embodiment of the present disclosure;

FIG. 3 illustrates a side sectional view of one of the cylinders of the internal combustion engine of FIG. 1, in accordance with the embodiment of the present disclosure;

FIG. 4 illustrates a side sectional view of one of the cylinders of the internal combustion engine of FIG. 2, in accordance with the alternate embodiment of the present disclosure;

FIG. 5 illustrates a bottom view of a cylinder head of the internal combustion engine taken along a sectional line 5-5′ of FIG. 3, in accordance with an exemplary embodiment of the present disclosure; and

FIG. 6 illustrates a bottom view of the cylinder head of the internal combustion engine taken along a sectional line 6-6′ of FIG. 4, in accordance with the exemplary embodiment of the present disclosure.

### DETAILED DESCRIPTION

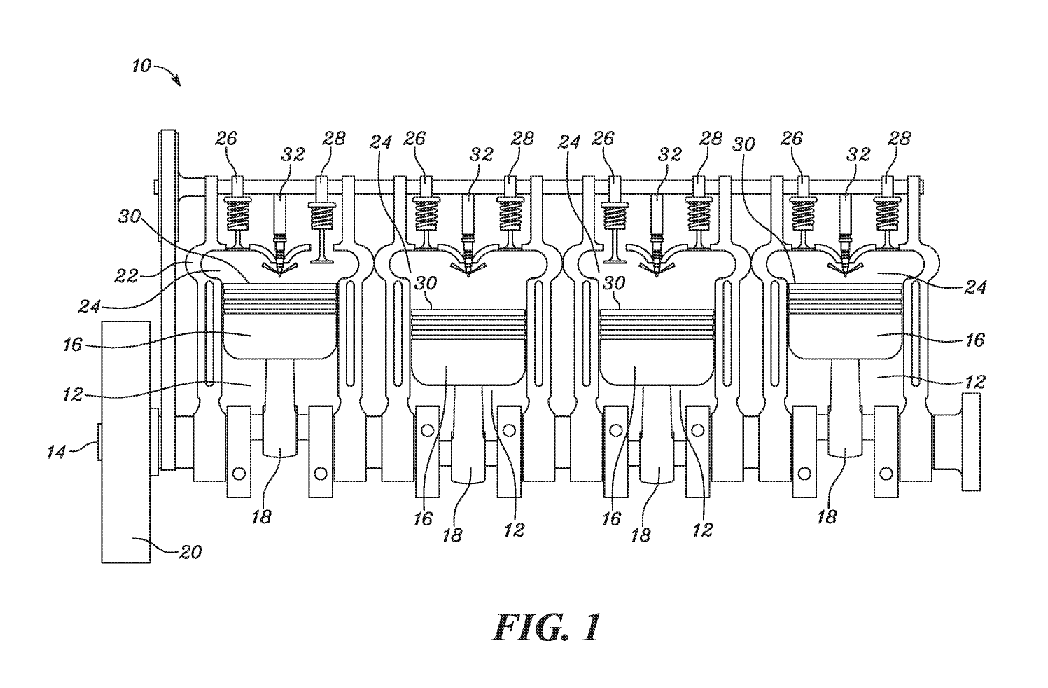

Referring to FIG. 1, an internal combustion engine 10 includes an engine cylinder 12. In an embodiment, the internal combustion engine 10 includes four engine cylinders 12. The four engine cylinders 12 are mounted in a straight line, one after another, along a crankshaft 14. The internal combustion engine 10 is provided with a piston 16 disposed within the engine cylinder 12 and is adapted to perform reciprocating movement within the engine cylinder 12. The piston 16 is connected to the crankshaft 14 via a connecting rod 18. The crankshaft 14 is coupled to a flywheel 20. The flywheel 20 imparts rotational energy to the crankshaft 14 from time to time in order to keep the crankshaft 14 rotating. The flywheel 20 may also be used as a damper to absorb torsional vibrations and to smoothen the power output of the internal combustion engine 10. It would be apparent to one skilled in the art that the internal combustion engine 10 may have any number of engine cylinders 12 for performing operation without departing from the meaning and scope of the disclosure. It would be further apparent to one skilled in the art that the internal combustion engine 10 is a diesel engine or “compression ignition internal combustion engine” or any other kind of engine that performs a variety of operations associated with a particular industry without departing from the meaning and scope of the disclosure.

The internal combustion engine 10 includes a cylinder head 22 adapted to cover the engine cylinder 12. The internal combustion engine 10 further includes a combustion chamber 24. The combustion chamber 24 is that volume of the internal combustion engine 10 where a mixture of air and fuel burns during operation of the internal combustion engine 10. The internal combustion engine 10 is provided with one or more inlet valves 26 to allow entry of intake charge (i.e. air that may include diluents such as re-circulated exhaust gases) into the combustion chamber 24 and one or more exhaust valves 28 to allow exit of combustion products from the combustion chamber 24.

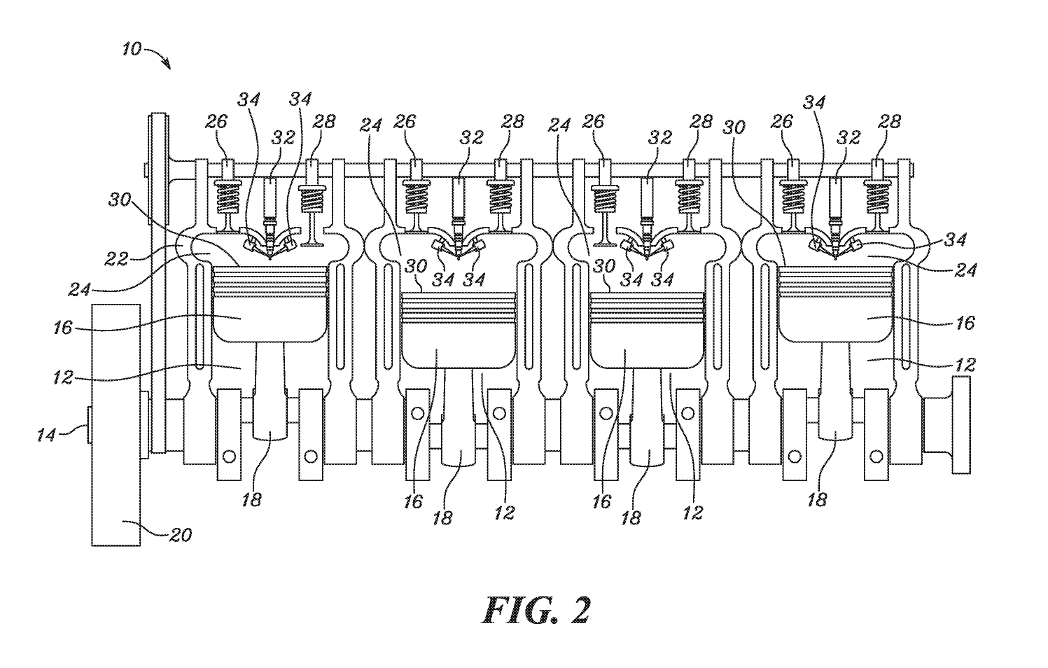

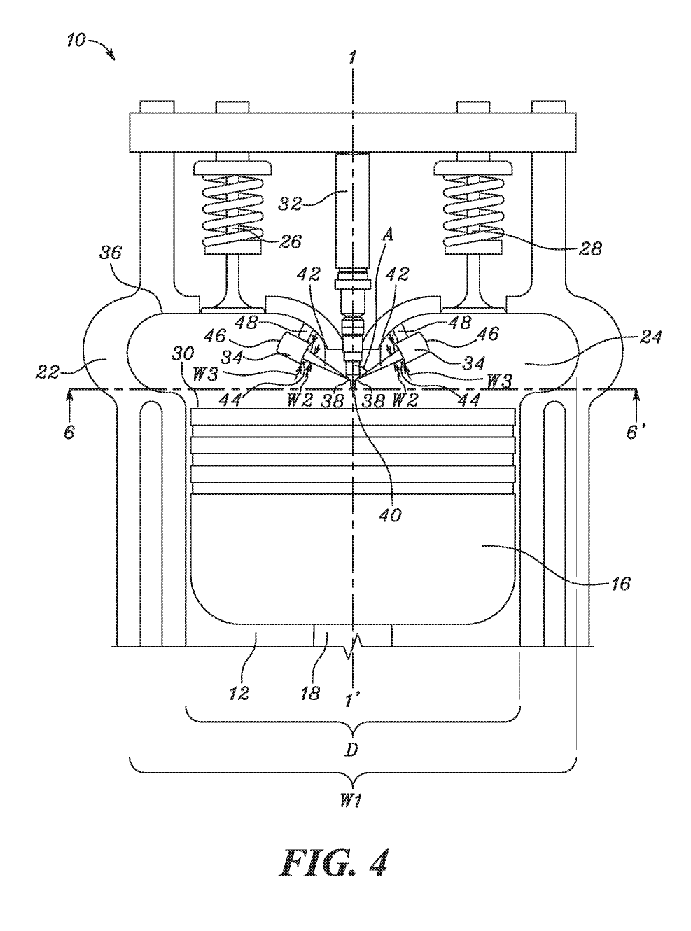

Referring to FIG. 2, in an alternate embodiment of the present disclosure, the internal combustion engine 10 is provided with the combustion chamber 24 having a number of ducts 34. The ducts 34 are adapted to provide a passage for the fuel injected into the combustion chamber 24. The alternate embodiment of the present disclosure will be described later in detail in conjunction with FIG. 4.

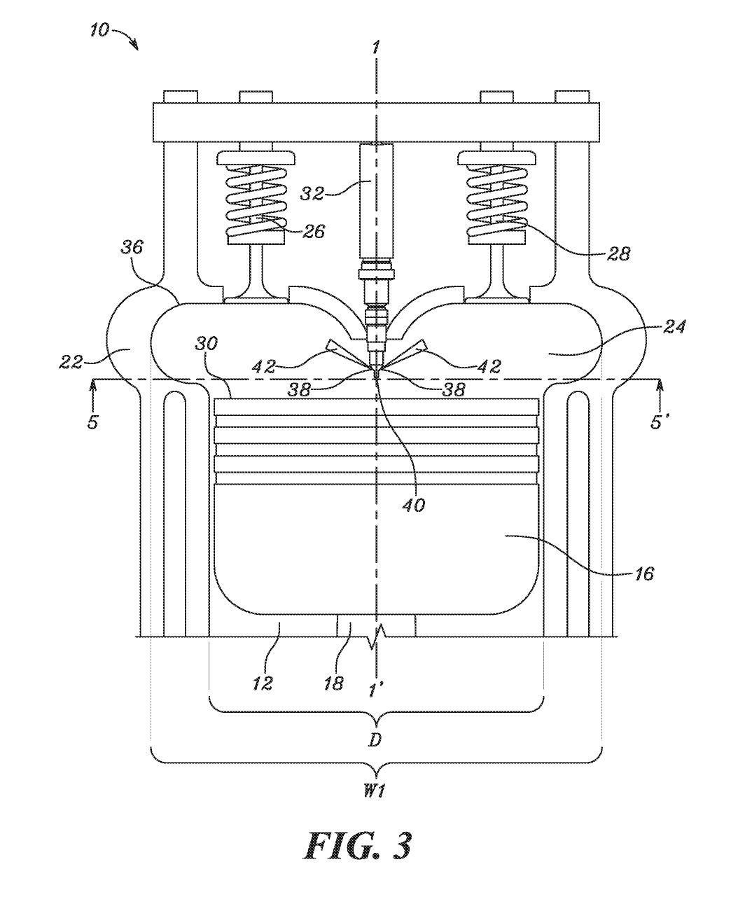

Referring to FIGS. 1, and 3, the cylinder head 22 has a depression 36 (i.e. a circular depression 36). The terms “depression” and “recess” have similar meaning and interpretation and may be interchangeably used within the specification without departing from the meaning and scope of the disclosure. The depression 36 has a predefined shape. The depression 36 extends beyond a bore of the engine cylinder 12. In an embodiment, the predefined shape corresponds to an inverted bowl shape. The combustion chamber 24 defines an enclosure (i.e. volume) bounded by the depression 36 of the cylinder head 22 and is further bounded by a crown 30 of the piston 16. The crown 30 of the piston 16 corresponds to a top surface of the piston 16 that is in fluid communication with gases in the combustion chamber 24. The combustion chamber 24 has the shape of the depression 36 of the cylinder head 22 i.e. the inverted bowl shape. The depression 36 of the cylinder head 22 is provided with an opening in the center for the placement of a fuel injector 32. The fuel injector 32 is coupled to the cylinder head 22 and is in fluid communication with the combustion chamber 24. The fuel injector 32 is adapted to supply fuel to the combustion chamber 24 via a number of orifices 38. In an embodiment, the orifices 38 are included at a tip 40 of the fuel injector 32. The orifices 38 introduce the fuel into the combustion chamber 24 in the form of fuel jets 42. It would be apparent to one skilled in the art that the orifices 38 may have any shape, numbers, or orientation depending on the shape of the combustion chamber 24 without departing from the meaning and scope of the disclosure.

The depression 36 of the cylinder head 22 extends beyond a bore of the engine cylinder 12 such that an effective width W1 of the depression 36 of the cylinder head 22 is greater than a diameter D of the engine cylinder 12 (also called a cylinder bore). The effective width W1 is an overall width of the depression 36 of the cylinder head 22 where the depression 36 is broadest. The piston 16 is adapted to perform reciprocating motion within the engine cylinder 12. In an embodiment, the crown 30 of the piston 16 has a flat shape. It would be apparent to one skilled in the art that the diameter D of the engine cylinder 12 corresponds to the diameter D of a bore of the engine cylinder 12 and the crown 30 of the piston 16 may be of any shape or design without departing from the meaning and scope of the disclosure.

Referring to FIGS. 1, and 2, during an intake stroke of the internal combustion engine 10, the piston 16 moves down in the engine cylinder 12 to allow the intake charge into the engine cylinder 12 and the intake charge enters into the combustion chamber 24 via the one or more inlet valves 26. During the compression stroke, the piston 16 moves up towards the cylinder head 22 compressing the intake charge. The compression of the intake charge increases the temperature inside the combustion chamber 24 of the internal combustion engine 10. At the end of the compression stroke, fuel is injected in the form of the fuel jets 42 into the combustion chamber 24 via the fuel injector 32. The fuel jets 42 disperse within the combustion chamber 24.

Following fuel injection, the fuel jets are ignited by the heat produced during compression. The piston 16 moves down due to pressure generated by combustion within the combustion chamber 24. The piston 16 drives the crankshaft 14 producing power. During the exhaust stroke, the combustion products are expelled by the one or more exhaust valves 28. It would be apparent to one skilled in the art that the fuel injection timing into the combustion chamber 24 via the fuel injector 32 may be retarded, and the combustion products may start to be expelled at the end of the power stroke and may end during the intake stroke without departing from the meaning and scope of the disclosure.

Referring to FIGS. 2, and 4, in an alternate embodiment of the present disclosure, the combustion chamber 24 is provided with the number of ducts 34. The ducts 34 are supported within the combustion chamber 24 by a number of support structures 48. The ducts 34 are in fluid communication with the orifices 38. The ducts 34 are adapted to provide a passage to the fuel exiting from the orifices 38 of the fuel injector 32. Each of the orifices 38 is oriented towards the corresponding each of the ducts 34. The ducts 34 are disposed in the combustion chamber 24 in a manner such that the fuel exiting from the orifices 38 substantially enters into the ducts 34. In the alternate embodiment, the ducts 34 (as shown in FIGS. 2, and 4) have a cylindrical shape. It would be apparent to one skilled in the art that the ducts 34 may have any shape including, but not limited to, cylindrical, conical, pyramidal, and prismatic among others and the ducts 34 may be solid, perforated, cooled, or uncooled without departing from the meaning and scope of the disclosure. It would be further apparent to one skilled in the art that the ducts 34 may be supported by any coupling means or using any other structure including bracket, mount, wire among others without departing from the meaning and the scope of the disclosure.

Referring to FIG. 4, each of the ducts 34 has an inlet 44 and an outlet 46. The fuel exiting from the orifices 38 enters each of the ducts 34 via the inlet 44 and exit from the outlet 46 after flowing through the ducts 34. The fuel jets 42 have a width W2 before entering the ducts 34. The inlet 44 of each of the ducts 34 has a width W3. The width W2 of the fuel jets 42 is less than the width W3 of the inlet 44 of each of the ducts 34 to allow the fuel jets 42 to flow substantially through the ducts 34. The ducts 34 extend at a predefined angle A with respect to a vertical axis 1-1′ of the engine cylinder 12. The predefined angle A corresponds to that angle that facilitates injection of the fuel towards the depression 36 of the cylinder head 22 within the combustion chamber 24 to provide efficient combustion.

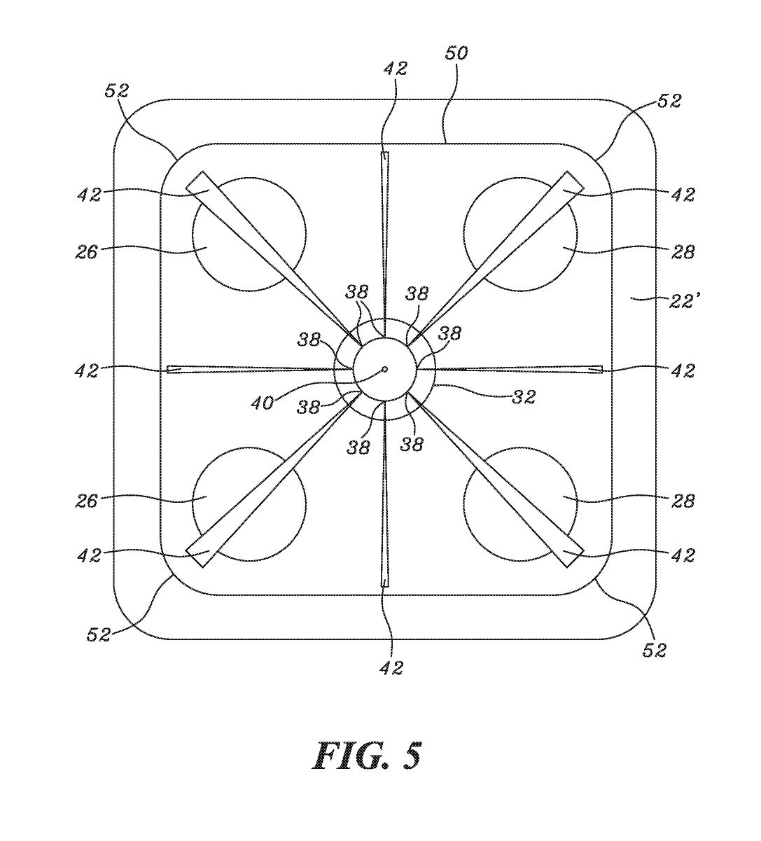

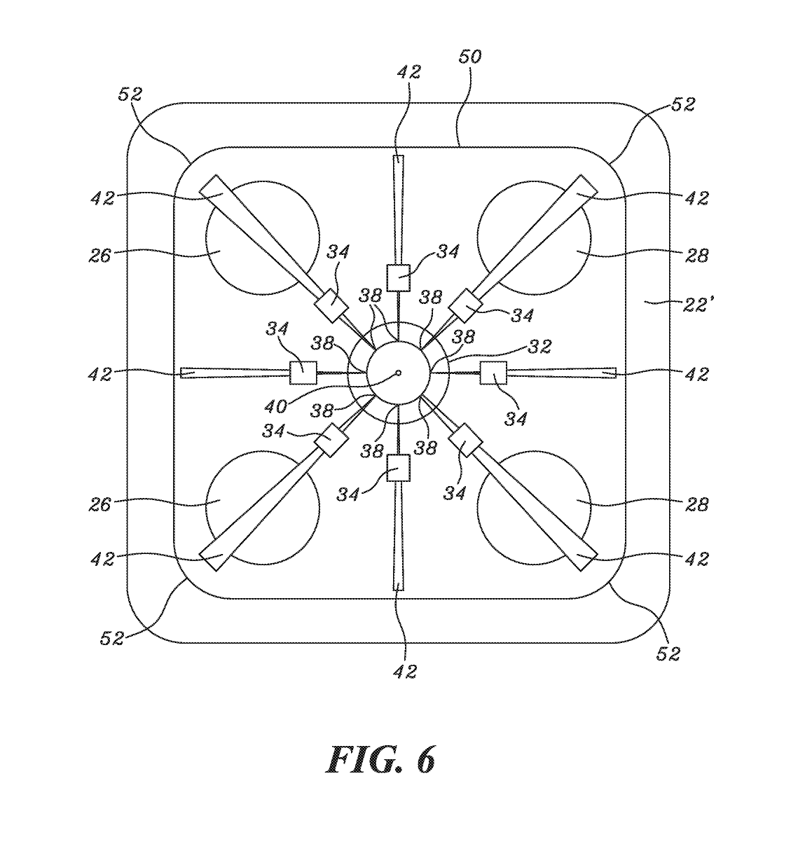

Referring to FIGS. 5, and 6, in an exemplary embodiment, a top surface 50 of a cylinder head 22′ has a square shape with corners 52 (i.e. rounded corners 52). The dimensions of the orifices 38 vary depending on the orientation towards the cylinder head 22′. The number of orifices 38 has two sizes. The orifices 38 that are oriented towards the corners 52 of the top surface 50 of the cylinder head 22′ are larger in size than the orifices 38 that are oriented towards the sides of the top surface 50 of the cylinder head 22′. It would be apparent to one skilled in the art that the orifices 38 that are oriented towards the corners 52 of the top surface 50 of the cylinder head 22′ may be larger or smaller in size than the orifices 38 that are oriented towards the sides of the top surface 50 of the cylinder head 22′ without departing from the meaning and the scope of the disclosure. In the exemplary embodiment there are eight orifices 38 and eight corresponding fuel jets 42.

### INDUSTRIAL APPLICABILITY

The present disclosure provides the internal combustion engine 10 with the cylinder head 22, having the depression 36, of predefined shape. The effective width W1 of the depression 36, of the cylinder head 22, is greater than the diameter D of the engine cylinder 12 (i.e. cylinder bore). The large surface area of the depression 36, of the cylinder head 22, provides more space for the placement of the one or more inlet valves 26 and the one or more exhaust valves 28. The inlet valves 26 and the exhaust valves 28 of the internal combustion engine 10 are larger than those of a conventional engine, which provides for better engine breathing. The one or more inlet valves 26 and the one or more exhaust valves 28 have a large valve area for the flow of the intake charge through the one or more inlet valves 26 and the flow of the combustion products through the one or more exhaust valves 28. The large volume of the depression 36 of the cylinder head 22 also promotes longer lasting free-jet combustion.

The combustion chamber 24 is provided with the number of ducts 34. The ducts 34 extend at the predefined angle A with respect to the vertical axis 1-1′ of the engine cylinder 12. The predefined angle A corresponds to that angle that facilitates injection of fuel towards the depression 36 of the cylinder head 22 and provides longer lasting free-jet combustion. At the predefined angle A, the fuel jets 42 after exiting from the ducts 34 are directed towards the depression 36 and throughout the volume of the combustion chamber 24. Therefore, the flame fronts emerging from the fuel jets 42 do not impinge directly on the crown 30 of the piston 16 and thus reduces thermal stresses in the piston 16. The reduction or absence of the thermal stresses reduces or eliminates the need for repeated oil cooling of the piston 16. At the predefined angle A, the fuel is injected towards the depression 36 so the flame has minimum interaction with crevices, especially in a cylindrical space between the piston 16 and the engine cylinder 12. The absence of such interactions promotes efficient working of the internal combustion engine 10 and increases durability of the engine cylinder 12. Also, the general design of the combustion chamber 24 enables less moving mass in the piston 16. The piston 16 has less material in it and has a simpler shape. Hence, the piston 16 may be manufactured from cheaper materials. Although, the fuel jets 42 do not directly impinge on the piston 16 wall-guided combustion may still be achieved to reduce NOx emissions. The ducts 34 extend at the predefined angle A that enables the fuel jets 42 to be injected at a fixed direction within the combustion chamber 24. Spray targeting of fuel is independent of the injection timing of the fuel, which eliminates the effects of spray targeting dependence on injection timing including, but not limited to, engine performance, and emissions among others. The ducts 34 also promote reduced or eliminated soot emissions from the internal combustion engine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An internal combustion engine comprising:
an engine cylinder;
a piston disposed within the engine cylinder and adapted to perform reciprocating movement within the engine cylinder;
a cylinder head is adapted to cover the engine cylinder, the cylinder head having a depression of a predefined shape such that an effective width of the depression of the cylinder head is greater than a diameter of the engine cylinder;
a combustion chamber defined as an enclosure between the depression of the cylinder head and a crown of the piston; and
a fuel injector in fluid communication with the combustion chamber, wherein the fuel injector is adapted to supply fuel to the combustion chamber via a plurality of orifices.

2. The internal combustion engine of claim 1 further comprising a plurality of ducts in fluid communication with the plurality of orifices and disposed within the combustion chamber, the plurality of ducts are adapted to provide a passage to the fuel exiting from the plurality of orifices.

3. The internal combustion engine of claim 2, wherein the plurality of ducts extend at a predefined angle with an axis of the engine cylinder to facilitate injection of the fuel towards the depression of the cylinder head within the combustion chamber to provide efficient combustion.

4. The internal combustion engine of claim 1, wherein the predefined shape of the depression of the cylinder head is circular.

5. The internal combustion engine of claim 1, wherein the predefined shape of the depression of the cylinder head has a square shape.

6. The internal combustion engine of claim 5, wherein the plurality of orifices has two sizes.
